(19) United States
(12) Patent Application Publication
(10) Pub. No.: US 2009/0152859 A1
(43) Pub. Date: Jun. 18, 2009

(54) Collection of sheets of paper and methods of forming a collection of sheets of paper

(76) Inventor: Supriti Bharma, Vancouver (CA)

Correspondence Address: WELLS ST. JOHN P.S., 601 W. FIRST AVENUE, SUITE 1300, SPOKANE, WA, 99201, US

(21) Appl. No.: 12/002,249

(22) Filed: Dec. 14, 2007

(51) Int. Cl. B42D 3/00; B42C 11/00; B42D 9/00

(52) U.S. Cl. 281/29; 281/42; 412/4

(57) ABSTRACT

A collection of sheets of paper includes a discrete first cover and a discrete second cover that is separate from the discrete first cover. A plurality of sheets of paper is secured between the first and the second covers. A string of material extends between the first cover and the second cover along respective edges of the first and second covers.

### TECHNICAL FIELD

The invention pertains to books, booklets, manuscripts, journals, pamphlets, notebooks, treatises and diaries, and any collection of sheets of paper or pages; and to methods of forming books, booklets, manuscripts, journals, pamphlets, notebooks, treatises and diaries, and any collection of sheets of paper or pages.

### BACKGROUND OF THE INVENTION

The conventional design and configuration for a collection of sheets of paper or pages (such as books, booklets, manuscripts, journals, pamphlets, notebooks, treatises and diaries) have a single, integral cover structure, or binder board, to protect a plurality of pages (referred to as a “journal” for simplicity). The single, integral cover structure (or binder board) includes a front portion, a back portion and a spine portion joining the front portion to the back portion. When a user selects a specific page to read or write, the conventional journal is opened to the specific page, but the journal will not remain open without force being applied by the user. Accordingly, the user cannot relax and concentrate on reading and writing without the aggravation of having to force the journal to remain open to the selected page.

Consequently, there is a need for a new design and configuration of a collection of sheets of paper that provide the capability of remaining open at any selected page without the user having to apply force to the page.

Moreover, applying a force to the conventional journal to keep the journal open creates a crease or fold in at least the spine portion. The crease in the spine portion can result in the eventual deterioration of the cover structure until the journal falls apart. Consequently, there is a need for a new design and configuration of a collection of sheets of paper that provide the capability of remaining open without applying a force to avoid the potential for deterioration of the journal.

Furthermore, once a conventionally designed cover structure deteriorates, there is no practical method of repairing and replacing the cover structure for continued use of the journal. Consequently, there is a need for a new design and configuration of a collection of sheets of paper that provide the capability of replacing and repairing the cover structure of the journal.

### SUMMARY OF THE INVENTION

One aspect of the invention includes a collection of sheets of paper. The collection includes a discrete first cover and a discrete second cover that is separate from the discrete first cover. A plurality of sheets of paper is secured between the first and the second covers. A string of material extends between the first and the second covers along respective edges of the first and the second covers.

Another aspect of the invention includes a journal. The journal has a first cover and a second cover discrete and separate from the first cover. A plurality of sheets of paper is secured between the first and the second covers. A spine secures the first cover to the second cover. The spine comprises a string of material.

A further aspect of the invention includes a method of forming a collection of sheets of paper. The method includes providing a plurality of sheets of paper. The method further includes securing the plurality of the sheets of paper between a first cover and a second cover. The first cover is separate and discrete from the second cover. The method includes forming a spine along a peripheral edge of the plurality of the sheets of paper. The spine comprises a strand of material extending from the first cover to the second cover.

Still further, another aspect of the invention includes a method of replacing a cover structure for a collection of sheets of paper. The method includes removing a plurality of sheets of paper from a cover structure. The method further includes providing a discrete first cover and providing a discrete second cover. The discrete first and second covers have openings spaced along respective periphery edges. The method includes securing the plurality of the sheets of paper between the discrete first and second covers. The method still further includes threading a strand of material through the openings of the discrete first and second covers.

### BRIEF DESCRIPTION OF THE DRAWINGS

Preferred embodiments of the invention are described below with reference to the following accompanying drawings.

FIG. 1 is a view of an assembly of exemplary components for a first exemplary embodiment of a collection of sheets of paper according to one of various exemplary embodiments of the present invention.

FIG. 2 is a view of a first exemplary embodiment of a method of forming the collection of sheets of paper of FIG. 1 according to one of various exemplary embodiments of the present invention.

FIG. 3 is a view of the collection of the sheets of paper of FIG. 1 shown at a method step subsequent to that shown in FIG. 2.

FIG. 4 is a view of the collection of the sheets of paper of FIG. 1 shown at a method step subsequent to that shown in FIG. 3.

FIG. 5 is a view of the collection of the sheets of paper of FIG. 1 shown at a method step subsequent to that shown in FIG. 4.

FIG. 6 is a perspective view of a second exemplary embodiment of a collection of sheets of paper shown in a partially open or closed position according to another of various exemplary embodiments of the present invention.

FIG. 7 is a plan view of the collection of sheets of paper of FIG. 6 in an exemplary open position according to one of various exemplary embodiments of the present invention.

FIG. 8 is a plan view of the collection of sheets of paper of FIG. 6 in an exemplary closed position according to one of various exemplary embodiments of the present invention.

FIG. 9 is a rear side, elevational view of the collection of sheets of paper of FIG. 6.

FIG. 10 is a bottom plan view of the collection of sheets of paper of FIG. 6.

FIG. 11 is a front side, elevational view of the collection of sheets of paper of FIG. 6.

FIG. 12 is a top plan view of the collection of sheets of paper of FIG. 6.

FIG. 13 is a perspective view of an exemplary embodiment of a discrete front cover, a discrete rear or back cover and the relative operation of an exemplary embodiment of a fastener according to one of various exemplary embodiments of the present invention.

FIG. 14 is a fragmentary perspective view of FIG. 13 and demonstrates an exemplary method of forming a loop of material for a discrete cover according to one of various exemplary embodiments of the present invention.

FIG. 15 is view of the loop of material of FIG. 14 shown at a method step subsequent to that shown in FIG. 14.

FIG. 16 is a perspective view of a third exemplary embodiment of a collection of sheets of paper at an exemplary method step of forming the same according to one of various exemplary embodiments of the present invention.

FIG. 17 is a view of the collection of the sheets of paper of FIG. 16 shown at a method step subsequent to that shown in FIG. 16.

FIG. 18 is a view of the collection of the sheets of paper of FIG. 16 shown at a method step subsequent to that shown in FIG. 17.

FIG. 19 is a view of the collection of the sheets of paper of FIG. 16 shown at a method step subsequent to that shown in FIG. 18.

FIG. 20 is a view of the collection of the sheets of paper of FIG. 16 shown at a method step subsequent to that shown in FIG. 19.

FIG. 21 is a perspective view of the collection of the sheets of paper of FIG. 16 shown in a partially open or closed position.

FIG. 22 is a plan view of the collection of sheets of paper of FIG. 16 in an exemplary open position according to another of various exemplary embodiments of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

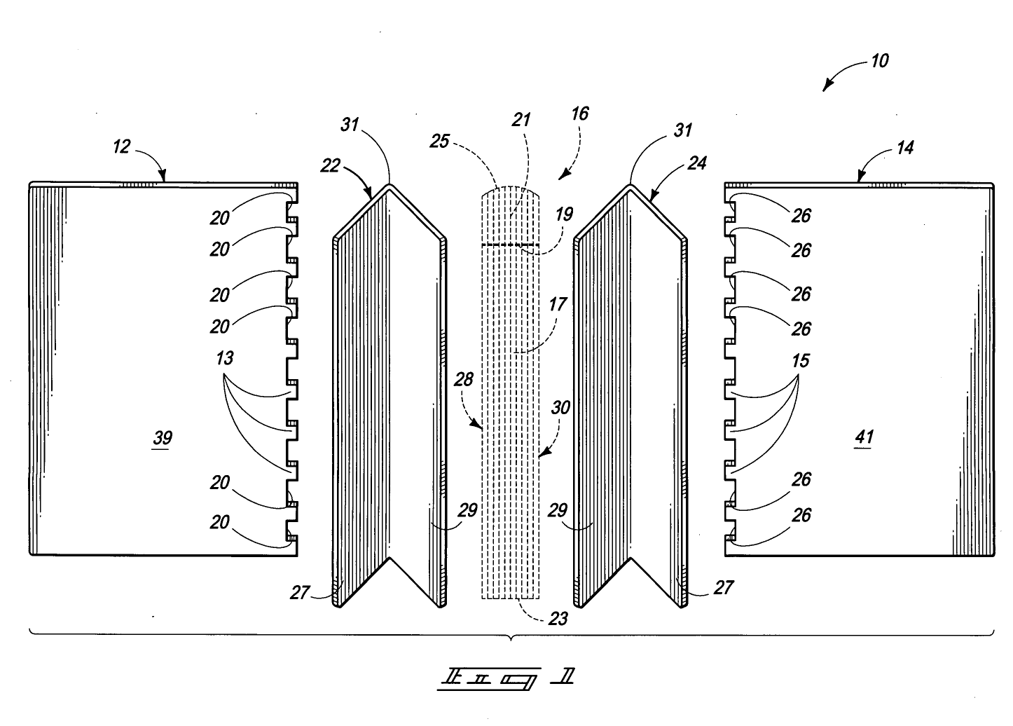

Referring to FIG. 1, exemplary components are illustrated for a first exemplary embodiment of a collection of sheets of paper 10 according to one of various exemplary embodiments of the invention. Various exemplary embodiments of a collection of sheets of paper 10 include a journal, book, booklet, pamphlet, notebook, treatise and diary.

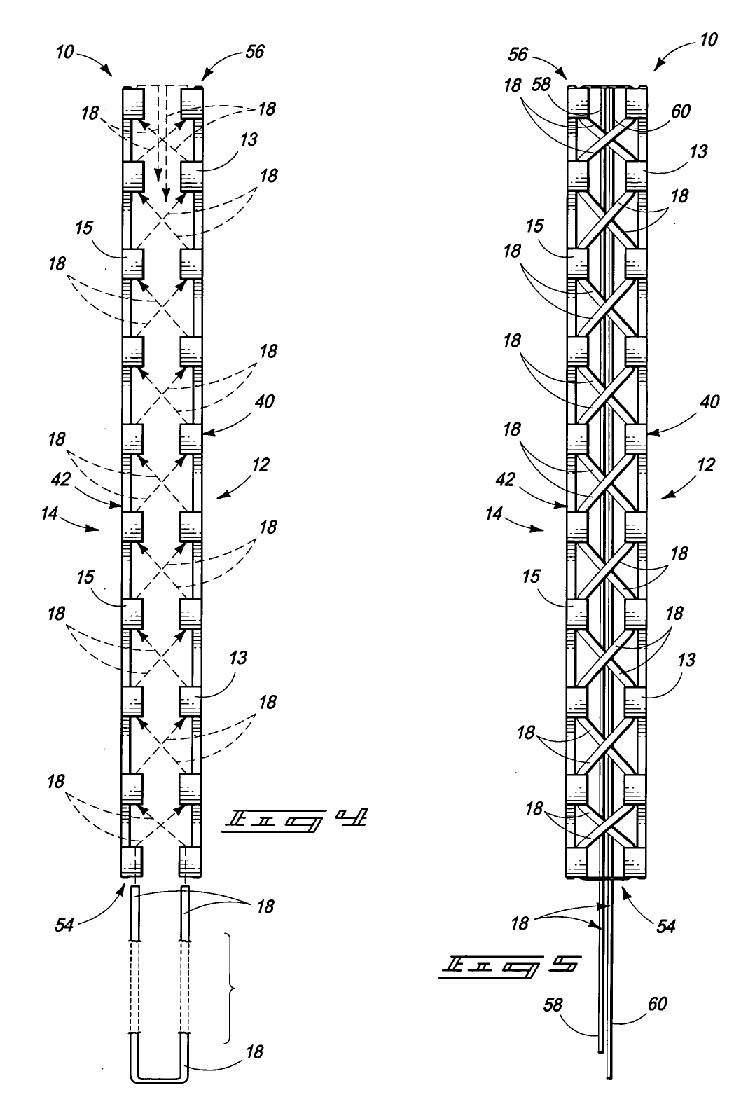

Still referring FIG. 1, the exemplary collection of sheets of paper 10 (hereinafter referred to as a collection 10) comprises a discrete first cover 12 that is separate from a discrete second cover 14. The first and second covers 12 and 14 are protective covers, or binder boards, for a set of a plurality of pages 16 wherein the first cover 12 is a front cover and the second cover 14 is a rear or back cover. An exemplary shape configuration of covers 12 and 14 is generally rectangular having respective rear peripheral edges 20 and 26. Other exemplary configurations for covers 12 and 14 include shapes such as a square, diamond, half circle, hexagon and octagon. Respective covers 12 and 14 can have the same shape configuration or different respective shape configurations. Exemplary materials for covers 12 and 14 include single materials of paper, cardboard, various metals, various plastic materials, rubber materials and fiberglass. Alternatively, exemplary materials for covers 12 and 14 include a combination of at least any two materials, the two materials can be the same materials or different materials. Exemplary covers 12 and 14 have respective first faces (or inside surfaces) 39 and 41 opposite respective outer faces (or outside surface) (shown in FIGS. 4-5). Furthermore, one of various exemplary embodiments of respective covers 12 and 14 includes a plurality of spaced loops of material 13 and 15 that extend from respective rear edges 20 and 26. Exemplary loops of material 13 and 15 will function as hinges wherein each hinge or loop of material 13 and 15 form an opening that extends through the length of the hinge structure (in the direction of rear edges 20 and 26). The function and advantage of the loops of material 13 and 15 will be described subsequently.

Still referring to FIG. 1, an exemplary collection 10 further includes a plurality of separate and individual sheets of paper joined or bound together as a set of pages 16 and routinely bound together with an adhesive along a rear periphery 25, for example, glued endpapers. In one exemplary embodiment of the invention, a plurality of sheets of paper or a set of pages 16 are purchased from a manufacturer already bound together. The pages 16, singularly and in the combination as a set, comprise a front periphery 17 opposite the rear periphery 25 and a top periphery 21 opposite a bottom periphery (not shown). The front periphery 17 intersects the top periphery 21 at a top corner 19 and intersects the bottom periphery (not shown) at a bottom corner 23. The set of pages 16 have a first lateral side 28 opposite a second lateral side 30. The front periphery 17, top periphery 21 and top corner 19 are routinely engaged and manipulated to pivot an individual page 16 or plurality of pages 16 from the next adjacent page 16.

Still referring to FIG. 1, an exemplary collection 10 includes a pair of attachment or fastener devices 22 and 24, and these fastener devices are optional structures for collection 10 which will be explained subsequently. For distinction, attachment device 22 can be referred to as a front attachment device 22 and attachment device 24 can be referred to as a rear attachment device 24. Each exemplary attachment device 22 and 24 has a cover portion 27 and a page portion 29. The cover portion 27 and the page portion 29 are connected at crease or corner 31 for each attachment device 22 and 24. Corner 31 provides pivot capabilities for either of the cover portion 27 and the page portion 29.

Still referring to FIG. 1, the exemplary collection 10 further includes a string or strand of material 18, shown in FIGS. 4-5, extending between respective covers 12 and 14 and which will be more thoroughly described subsequently. Exemplary materials for the strand or string of material 18 include fibrous material, such as cotton or flax, or other materials such as leather or metal. An exemplary strand or string of material 18 comprises at least one of a cord, yarn, leather, metal, wire, string, ribbon, thread, twine, rope, cable and various combinations of each one.

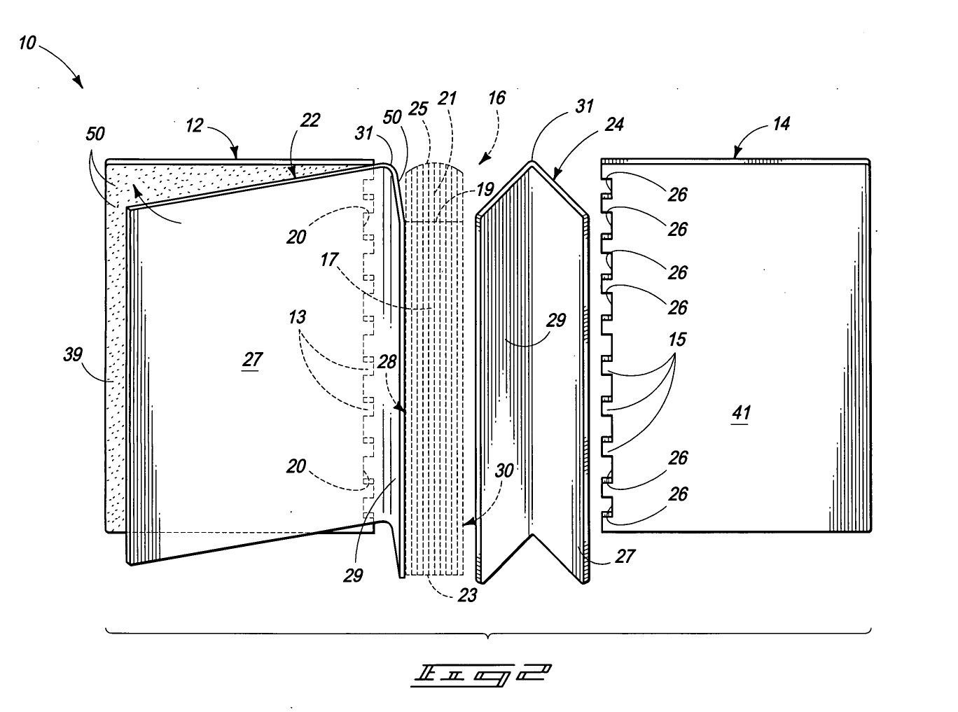

Referring to FIG. 2, a first exemplary embodiment of a method of forming the collection of sheets of paper 10 is illustrated and described according to one exemplary embodiment of the invention. An adhesive 50 is provided on the inside surface 39 of front cover 12. A backside (not referenced) of the cover portion 27 of front attachment device 22 is positioned against the adhesive 50 and inside surface 39 of front cover 12 to secure cover 12 to the attachment device 22. Alternatively, adhesive 50 can be provided only on the backside (not referenced) of the cover portion 27 to secure the attachment device 22 to cover 12. Additionally, adhesive 50 can be provided on both the backside of the cover portion 27 and on the inside surface 39 of cover 12 to secure the cover 12 to the attachment device 22.

Still referring to FIG. 2, an adhesive 50 is provided on the backside (not referenced) of the page portion 29 of front attachment device 22. The backside (not referenced) of the page portion 29 is positioned against the first lateral surface 28 (FIG. 1) of pages 16 to secure the attachment device 22 to pages 16. Alternatively, adhesive 50 can be provided only on the first lateral surface 28 (FIG. 1) of pages 16 to secure the attachment device 22 to pages 16. Additionally, adhesive 50 can be provided on both the first lateral surface 28 (FIG. 1) of pages 16 and on the backside (not referenced) of the page portion 29 of front attachment device 22 to secure the attachment device 22 to pages 16.

Still referring to FIG. 2, it should be understood that any surface having an adhesive applied can have the same adhesive 50 applied, and alternatively, each surface, can have a different adhesive applied. Moreover, it should be understood that cover portion 27 can be configured to overlay and be secured against any percentage portion of surface area of inside surface 39 of front cover 12. Similarly, it should be understood that page portion 29 can be configured to overlay and be secured against any percentage portion of surface area of the first lateral surface 28 (FIG. 1) of pages 16. Furthermore, it should be understood that cover 12 can be secured to device 22 first, or device 22 can be secured to pages 16 first, and device 22 can be secured to cover 12 and to pages 16 at substantially the same time (that is, simultaneously). Still further, an exemplary adhesive includes glue, cement, paste, mucilage and epoxy. Additionally, the adhesive selected can be conducive to at least one of the materials being secured together, such as glue that is conducive to paper, cardboard, rubber, plastic and/or metal.

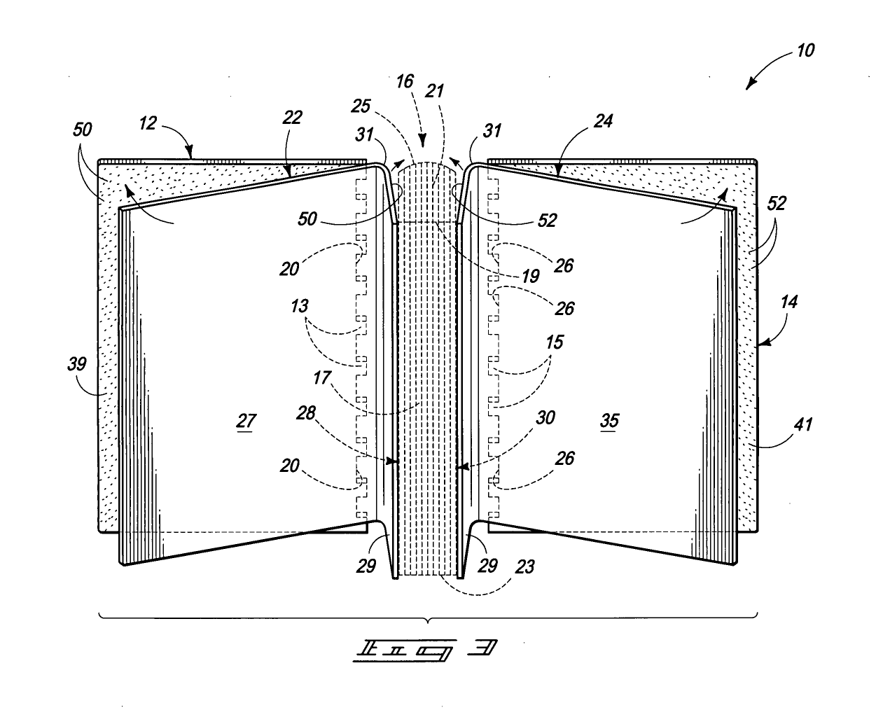

Referring to FIG. 3, an adhesive 52 is provided on any selected order of surfaces as discussed previously with respect to adhesive 50 of FIG. 2. Additionally, rear cover 14 is secured to the second lateral side 30 of pages 16 via rear attachment device 24 as described previously with respect to cover 12 and attachment device 22 of FIG. 2. Accordingly, all previous discussions with respect to FIG. 2 are applicable to FIG. 3.

Referring to FIGS. 2-3, it should be understood that cover 12 can be secured to pages 16 before cover 14 is secured pages 16. Alternatively, it should be understood that cover 14 can be secured to pages 16 before cover 12 is secured to pages 16. Additionally, cover 12 can be secured to pages 16 substantially at the same time as cover 14 is secured to pages 16 (that is, simultaneously). Further still, as stated previously, attachment devices 22 and 24 are optional wherein respective covers 12 and 14 can be secured directly to respective lateral sides 28 and 30 of pages 16 without attachment devices 22 and 24.

Referring to FIGS. 4-5, a first exemplary method of connecting cover 12 and cover 14 of the collection of sheets of paper 10 with the strand or string of material 18 is illustrated according to one of various exemplary embodiments of the invention. Pages 16 are not shown in FIGS. 4-5 for simplicity. Referring to FIG. 4, the string of material 18 connects front and rear covers 12 and 14 by fastening, lacing, tying, weaving, interlacing and/or intertwining between respective loops of material 13 and 15 (hereinafter referred to as loop or loops). An exemplary method of connecting includes folding the string of material 18 (hereinafter referred to as string 18) to position opposite ends of string 18 through opposite openings in respective loops of material 13 and 15 of respective covers 12 and 14.

Alternatively, another method of connecting includes beginning with a single end of string 18 and positioning the single end through respective loops 13 and 15 of respective covers 12 and 14. The single end of string 18 can be first positioned in a first loop beginning with either cover 12 and 14. Additionally, the single end of string 18 can be first positioned in any one loop located along respective rear peripheral (or lateral or periphery) edges 20 and 26 of respective covers 12 and 14. For example, the single end of string 18 can be first positioned in a loop located in the middle of one of the rear peripheral edges of one of the covers.

In one of various exemplary methods of connecting, string 18 is woven in an exemplary crisscrossing pattern (illustrated by dashed arrows in FIG. 4) beginning with loops 13 and 15 at the bottom 54 of respective covers 12 and 14. In another of various exemplary methods of connecting, string 18 is woven in an exemplary crisscrossing pattern beginning with loops 13 and 15 at the top 56 of respective covers 12 and 14. In still another method of connecting, string 18 can be interlaced beginning with any one loop located at any location along respective rear periphery edges 20 and 26 of respective covers 12 and 14.

Still referring to FIGS. 4-5, another of various exemplary methods of connecting includes string 18 being woven beginning with loops 13 and 15 at the top 56 of respective covers 12 and 14 and terminating with loops 13 and 15 at the bottom 54 of respective covers 12 and 14. Another of various exemplary methods of connecting, string 18 is woven beginning with loops 13 and 15 at the bottom 54 of respective covers 12 and 14 and terminating with loops 13 and 15 at the top 56 of respective covers 12 and 14. An exemplary termination of weaving the loops 13 and 15 comprises tying the string 18 between respective covers 12 and 14.

It should be understood that with string 18 interlaced or woven through loops 13 and 15 of respective covers 12 and 14, string 18 forms a spine of the collection of sheets of paper 10. An exemplary spine of the invention is formed by string 18 extending along the rear peripheral edges 20 and 26 of respective covers 12 and 14 and extending along the rear periphery 25 of the plurality of sheets of paper 16. It should be further understood that another of various exemplary methods of connecting includes weaving or interlacing a plurality of strings of material 18 through respective loops 13 and 15. Additionally, each one of the plurality of strings of material can be woven through the loops 13 and 15 in the same pattern or in different patterns relative to any one other string of material 18. Exemplary different patterns include having a first string 18 woven beginning at the top of covers 12 and 14 and a second string 18 woven beginning at the bottom of covers 12 and 14.

Referring to FIG. 5, another exemplary method of connecting covers 12 and 14 with string 18 includes providing a sufficient length of material for string 18 to have at least one portion (with two portions shown) 58 and 60 extending from respective covers 12 and 14. Portions 58 and 60 of string 18 comprise two separate and distinct bookmarks and are formed from opposite end portions of string 18. In another exemplary method of connecting covers 12 and 14 with string 18 includes providing a sufficient length of material for string 18 to have a single portion extending from covers 12 and 14 to form a single bookmark.

Still referring to FIG. 5, in use, portions 58 and 60 provide the capability of marking two locations in a book or journal (pages 16 not shown for simplicity). Furthermore, this exemplary embodiment of the invention will have two bookmarks 58 and 60 that are integral with the structure of the collection 10, and therefore, misplacing the bookmarks can be avoided. Additionally, conventional bookmarks separately attached or secured to a cover structure or set of pages have a tendency to break away from the book or journal to be lost. The inventive bookmark being integral with the spine of the book or journal is more stable or secured and not apt to be dislodged from the book or journal. Still further, since the bookmarks are integral with the spine of collection 10 and not discrete from collection 10, the bookmarks of the invention will not have to be separately attached or secured to the collection 10 simplifying the method of producing collection 10.

Another exemplary embodiment of collection 10 includes the two bookmarks 58 and 60 having different lengths allowing for respective ends of bookmarks 58 and 60 to be located at different distances from collection. The two bookmarks 58 and 60 having different lengths allows for distinguishing between the two bookmarks improving the capability to distinguish between two different locations in the collection 10. Alternatively, for another embodiment of the invention, the two bookmarks can terminate at substantially the same or equal lengths from bottom 54 of book 10.

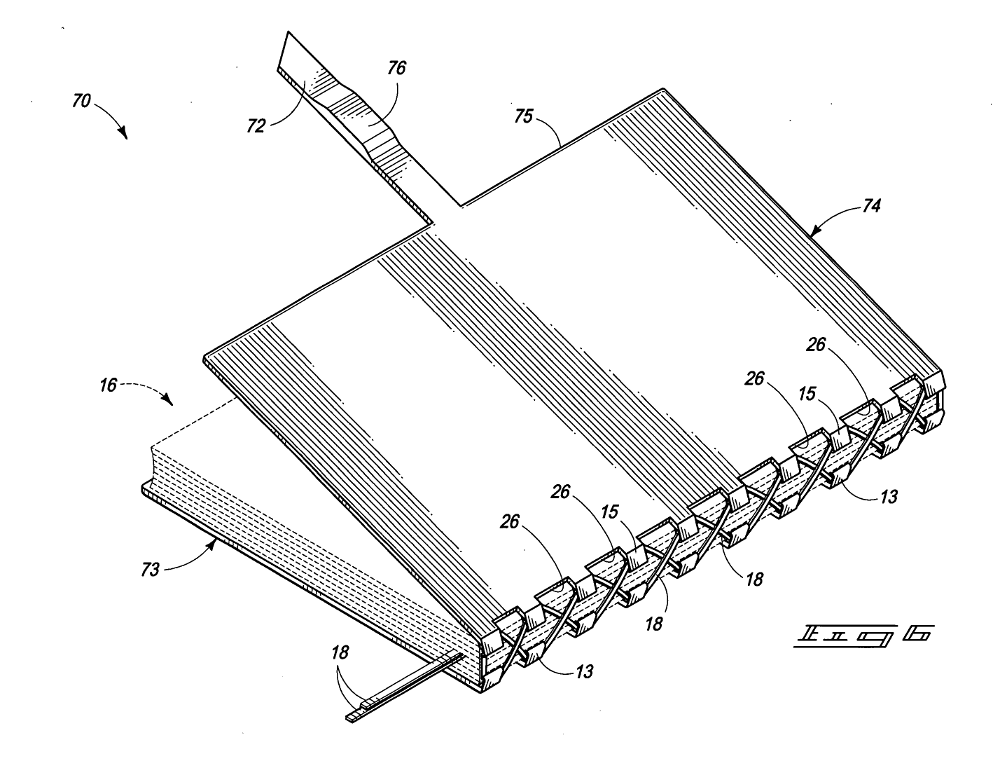

Referring to FIG. 6, a second exemplary embodiment of a collection of sheets of paper 70 is illustrated according to another exemplary embodiment of the invention. The same reference numbers used in the first embodiment of the invention will be used to represent the same structures and methods for this embodiment of the invention. It should be understood that all previous discussions with respect to the first embodiment that are compatible with this embodiment are applicable to this embodiment.

Still referring to FIG. 6, an exemplary collection 70 differs from collection 10 in that collection 70 has a rear cover 74 that includes a fastener or clasp 72. Other exemplary embodiments of collection 70 are a hook, buckle, and/or clamp. Fastener 72 is configured to be secured to the other of the first and the second covers which in the illustrated embodiment is an exemplary front cover 73. That is, fastener or clasp 72 is used to fasten or secure collection 70 in a closed position with front cover 73 and rear cover 74 urged against respective lateral sides 28 and 30 of pages 16. In the shown exemplary embodiment of fastener 72, fastener 72 is secured to or integral with rear cover 74 and extends from a side edge 75 of cover 74. Alternatively, the fastener 72 can be secured to or integral with front cover 73.

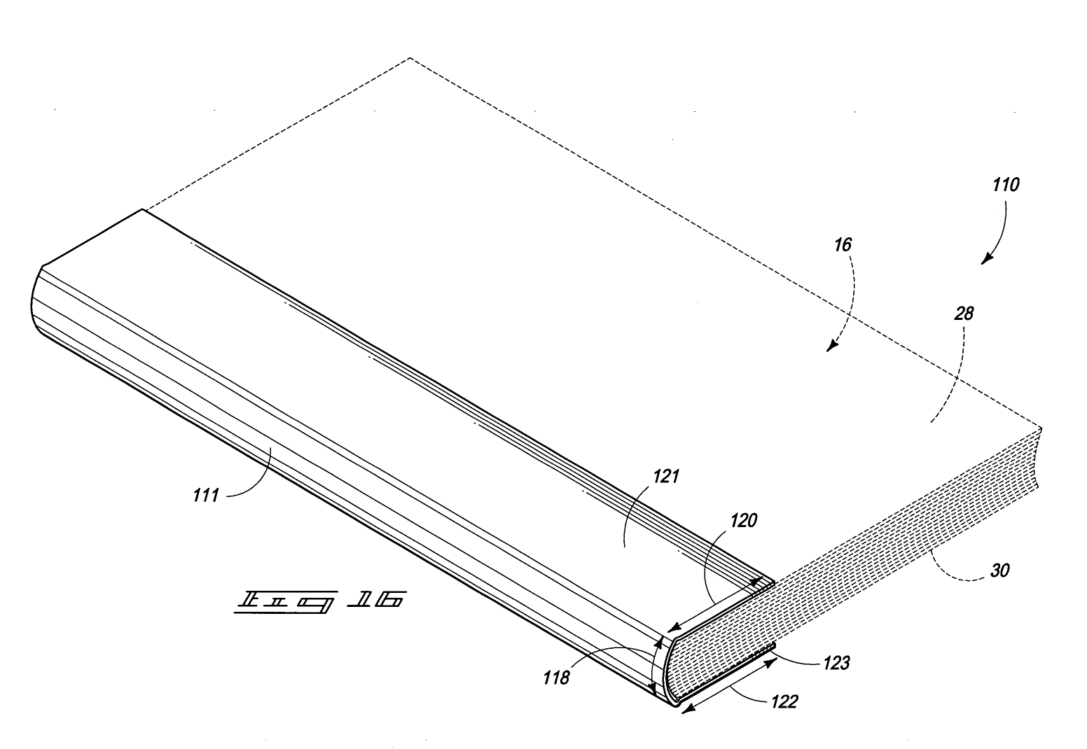

Still referring to FIG. 6, for one exemplary embodiment of fastener 72, fastener 72 includes an enlarged region 76 that houses a magnet (referenced as 77 in FIG. 14). Alternatively, fastener 72 includes an enlarged region 76 that houses a type of material or metal that is attracted to a magnet (also referred to as a magnetizable material). The fastener 72 is configured to be positioned relative the other cover to establish an attraction relationship between the magnet and the magnetizable material. If the exemplary embodiment of fastener 72 has the enlarged region 76 housing a magnet, then the other cover must be configured with a magnetizable material, or another magnet oriented to establish an attraction relationship when the magnet in fastener 72 is moved proximate. Alternatively, if the exemplary embodiment of fastener 72 has the enlarged region 76 housing a magnetizable material, then the other cover will be configured with a magnet oriented to be in an attractable relationship when the magnetizable material in fastener 72 is moved proximate the magnet.

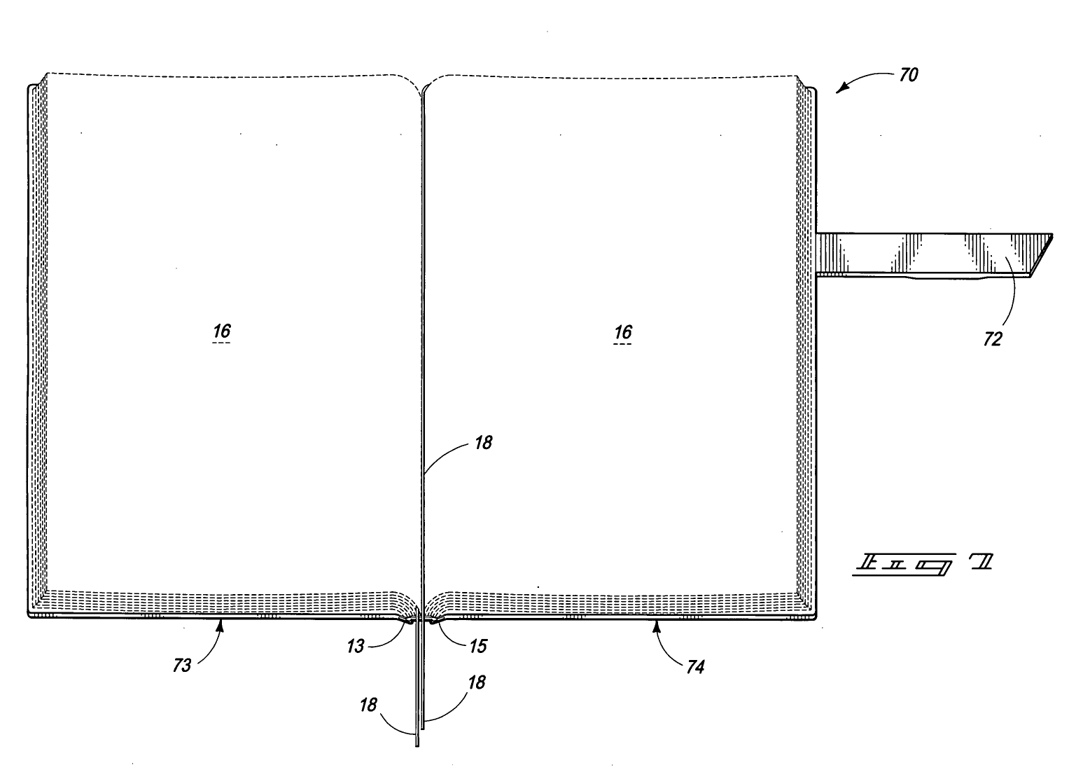

Referring to FIG. 7, an exemplary collection 70 can be referred to as a journal (although could be any other configuration previously listed with respect to the first embodiment of collection 10) and is illustrated in an open position. The configuration of this open position is one of various advantages of the present invention. The embodiments of the invention disclosed include discrete covers and a spine comprising a string or strand of material that allows the journal 70 to lie open on a surface and remain open without applying a pressure or force to one or both of pages 16 over respective covers. This is not the case with conventional configurations of journals and books. Conventional configurations of journals and books will require applying a pressure or force to one or both of pages 16 over respective covers to keep the conventional journal or book open. Alternatively, a great amount of pressure or force can be applied to fold the conventional book or cover. However, the conventional configuration routinely does not remain with the selected page remaining in position to be viewed. Moreover, when a great amount of pressure or force is applied to fold the conventional book or cover, a crease will develop in the spine which can eventually result in a deterioration of the spine and the conventional journal or book.

However, the new inventive journal or book will remain in the open position without any applied force or pressure so a reader (or writer) can relax and concentrate on reading (or writing). Additionally, the journal 70 will remain in an open position on an angled (not just a flat surface), for example, a surface that forms an angle less than 180°. Furthermore, the inventive embodiments for collections of sheets of paper will remain open at the selected page unlike the conventional books and journals.

Referring to FIG. 8, journal 70 is illustrated in an exemplary closed position with fastener 72 over front cover 73.

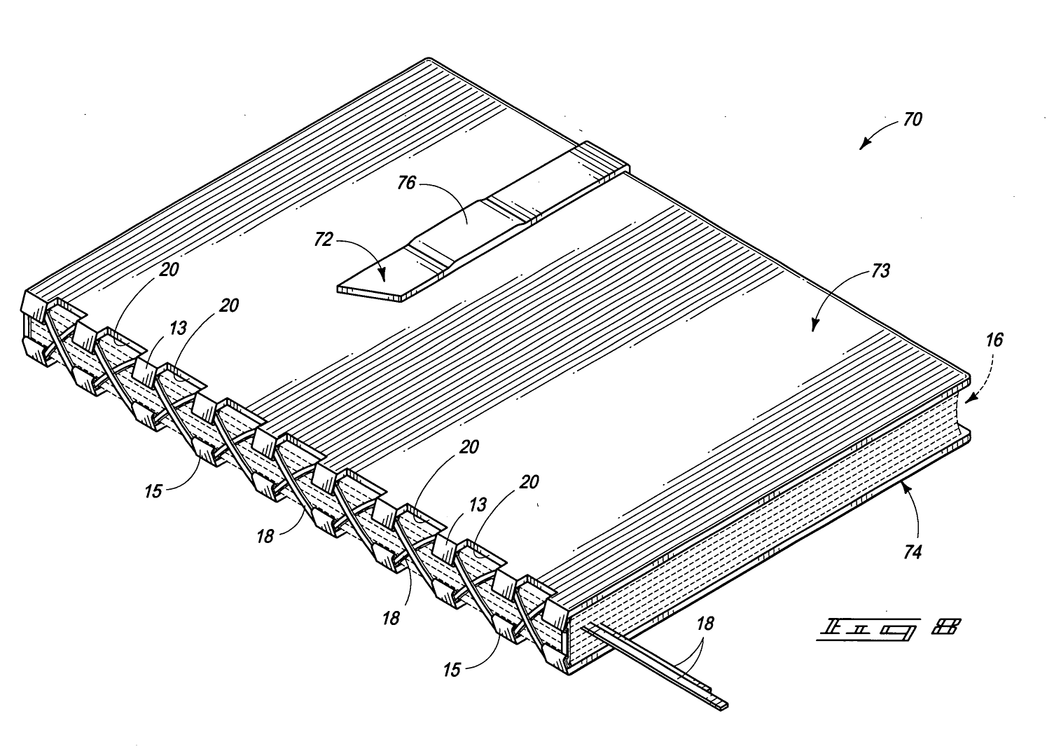

Referring to FIG. 9, a view of journal 70 is illustrated with journal 70 in the closed position. This exemplary view illustrates the spine comprising string 18 and the rear periphery 25 of pages 16 shown through the string 18. It should be understood that the various embodiments described throughout this application can have a spine that includes the rear periphery 25 of pages 16 and the string or strand of material 18. An advantage of this spine the comprises string 18 is the spine acts as a protective sheath or barrier while the journal 70 is in the open position protecting the glued or sewn rear periphery of pages 16 from wear and tear, and from contamination by dirt.

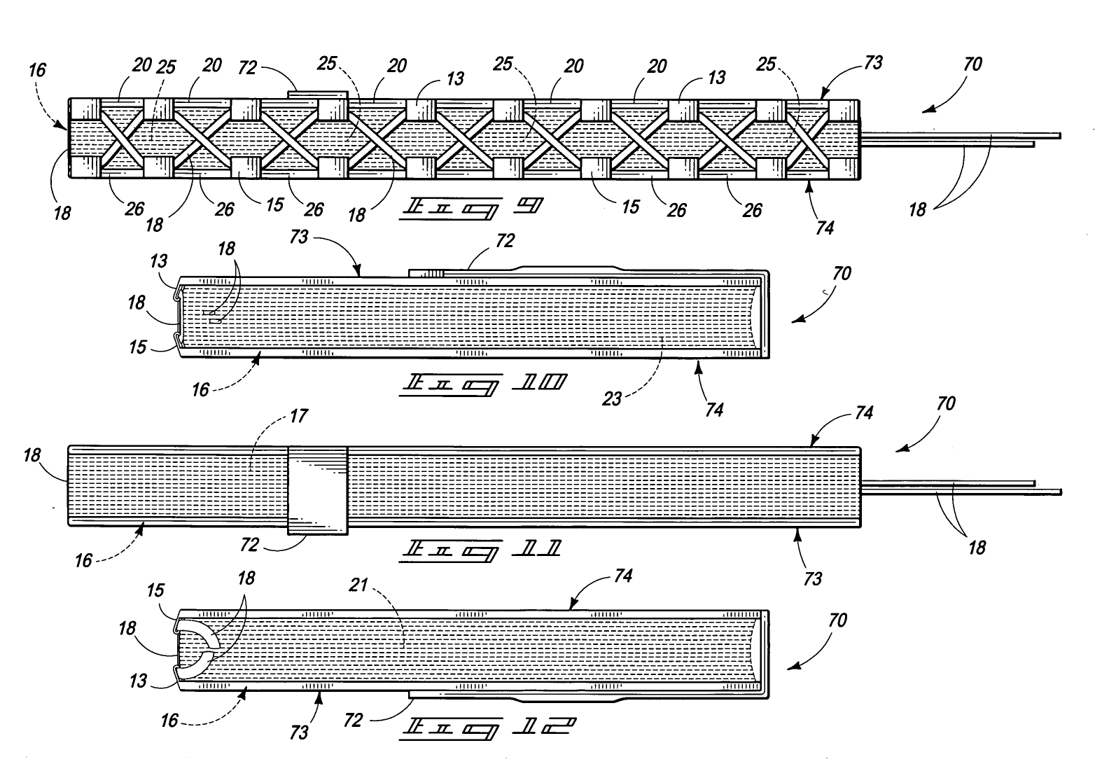

Referring to FIG. 10, journal 70 is shown in the closed position and the view illustrates the bottom of journal 70.

Referring to FIG. 11, journal 70 is shown in the closed position and the view illustrates the front periphery or edges 17 of pages 16.

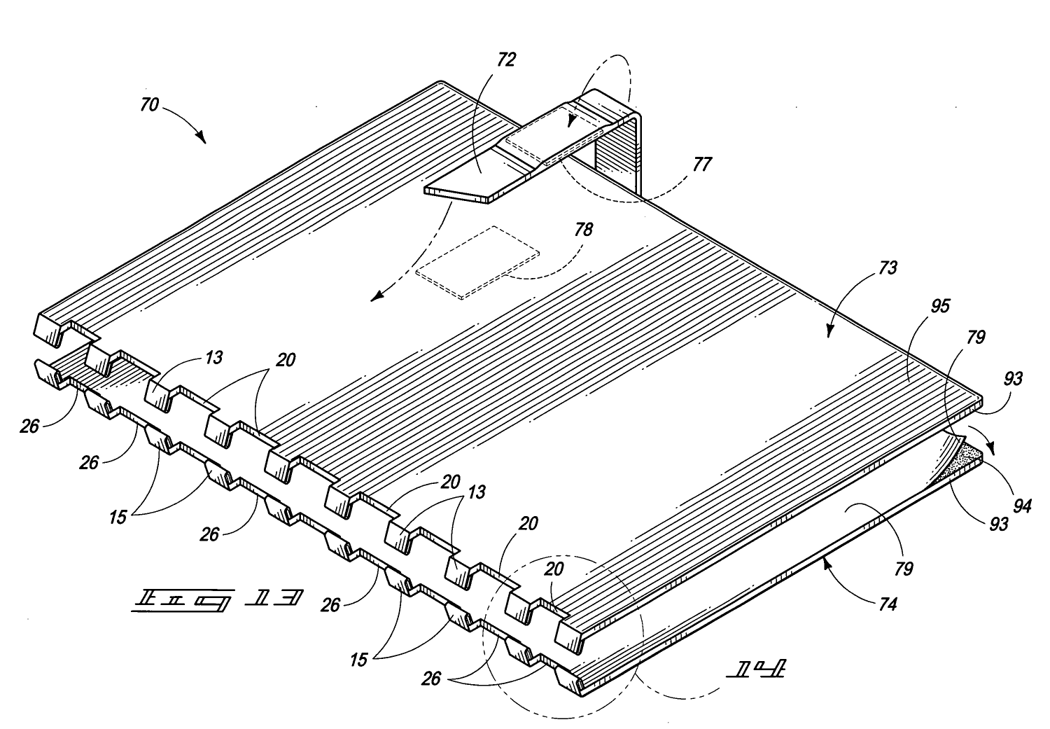

Referring to FIG. 12, journal 70 is shown in the closed position and the view illustrates the top of journal 70 with the top periphery or edges 21 of pages 16 shown.

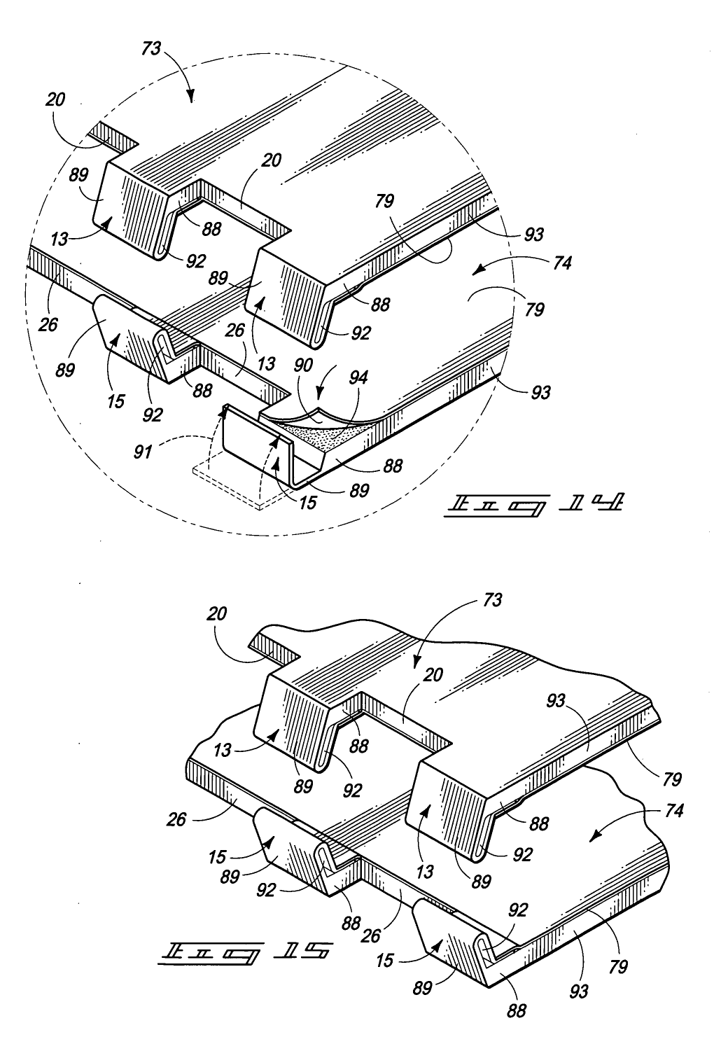

Referring to FIG. 13, an exemplary step of positioning fastener 72 relative front cover 73 of journal 70 is illustrated. Cover 73 includes the magnet or magnetizable material 78 and fastener includes the magnet or magnetizable material 77. In this exemplary position of fastener 72, the position can represent an opening of book 70 wherein the fastener 72 is being unfastened or removed from front cover 73. Alternatively, this exemplary position of fastener 72 can represent a closing of book 70 wherein the fastener 72 is being fastened or moved to front cover 73.

Still referring to FIG. 13, closing journal 70 can include moving fastener 72 over and around the front periphery of journal (periphery opposite the spine). The closing of journal 70 includes positioning structure 77 (magnetizable material or magnet) in proximity to structure 78 (magnetizable material or magnet) of front cover 73 until an attractive relationship is established. Conversely, an exemplary step of opening journal 70 includes removing fastener 72 from front cover 73.

Still referring to FIG. 13, each exemplary cover 73 and 74 comprise a plurality of structures or materials. For example, each cover 73 and 74 includes a first material or a first structure which will be termed an outside structure 93 for convenience. Additionally, each cover 73 and 74 includes a second material or a second structure which will be termed an inside structure 79 for convenience. Each outside structure 93 includes an inner surface 94 (shown for cover 74) and an outer surface 95 (shown for cover 73). It should be understood that outer surface 95 forms the outermost surface of journal 70 being the outward surfaces of respective covers 73 and 74.

Still referring to FIG. 13, inside structure 79 is secured over the inner surface 94 of each outside structure 93 to form each cover 73 and 74 having a plurality of structures or materials. Inside structure 79 is secured to outside structure 93 by an adhesive or other fastener such has stables, tacks or nails. An exemplary inside structure 79 and an exemplary outside structure 93 can each be formed from at least one of the following materials: fiberglass, plastic, paper, rubber, metal, cardboard or any combination thereof. In one embodiment of the invention, inside structure 79 can be formed of the same material and have the same shape configuration as outside structure 93. Alternatively, inside structure 79 can have at least one of (or both) the material and the shape configuration to be different from the outside structure 93. Additionally, one or both covers 73 and 74 can comprise a single material or single structure. Furthermore, one cover can have a completely different (shape and material) from the other cover, or partly the same, or entirely the same.

Referring to FIGS. 14-15, an exemplary method of forming hinges or loops of material (also referred to as loops) 13 and 15 is described and is applicable to all embodiments described in this application. Referring to FIG. 14, rear and front covers 73 and 74 are shown each having the same configuration comprising two structures, the inside structure 79 and the outside structure 93. Each outside structure 93 comprises rectangular projections 88 that extend laterally outward from respective rear peripheral edges 20 and 26 of covers 73 and 74. Exemplary embodiments of rectangular projections 88 are spaced along the rear peripheral edges 20 and 26. Moreover, a portion 90 of inside structure 79 is provided over the rectangular projections 88 of outside structure 93. Each rectangular projection 88 has a flap of material 89 (also referred to as flap) extending from the outer surface 95 of the outside structure 93 of covers 73 and 74. Flaps 89 extend from the rectangular projection 88 generally along or parallel to the same plane as the rectangular projections 88 extend from the rear peripheral edges 20 and 26 of covers 73 and 74.

Still referring to FIGS. 14-15, an exemplary method of forming loops 13 and 15 comprises lifting portion 90 of inside structure 79 to expose the inner surface 94 of the rectangular projection 88. Next, a section of flap 89 is moved upward along direction 91 and placed over and against the exposed inner surface 94 of the rectangular projection 88. In one exemplary embodiment of the method, the section of flap 89 is secured to the exposed inner surface 94 by an adhesive, for example, glue. Flap 89 is folded leaving an opening 92. Portion 90 of inside structure 79 is positioned back over rectangular projection 88 and against the section of flap 89 that was previously positioned against the exposed inner surface 94 of the rectangular projection 88. Portion 90 is secured to the section of flap 89 by an adhesive, for example, glue. It should be understood that portion 90 can be positioned over flap 89 without being secured to flap 89.

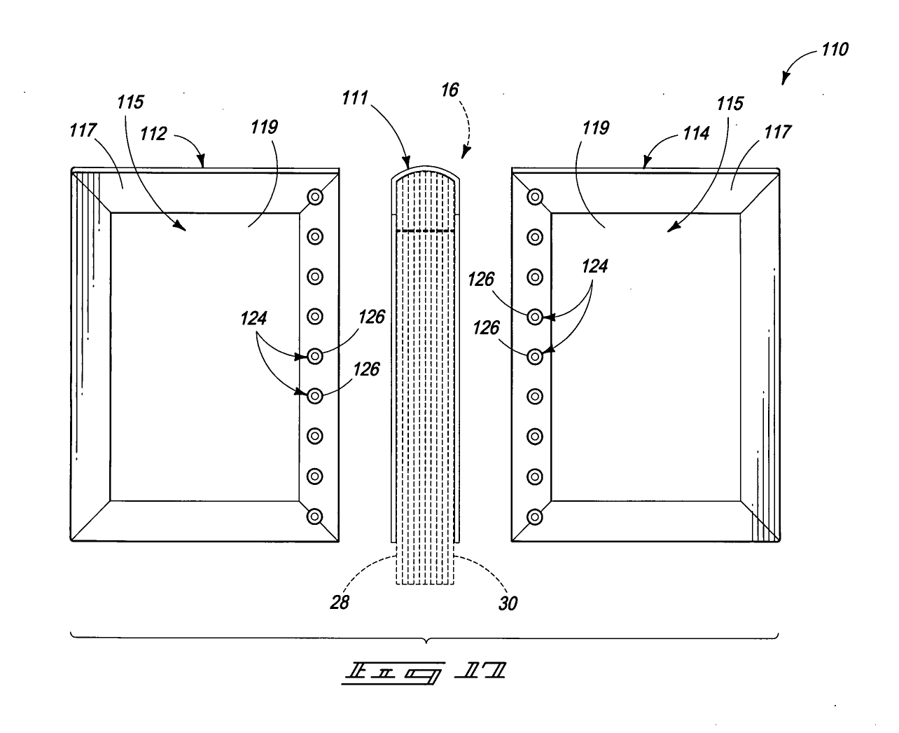

Referring to FIG. 16, a third exemplary embodiment of a collection of sheets of paper 110 is illustrated according to another exemplary embodiment of the invention. The same reference numbers used in the first embodiment of the invention will be used to represent the same structures and methods for this embodiment of the invention. It should be understood that all previous discussions with respect to the first and second embodiments that are compatible with this embodiment are applicable to this embodiment.

Still referring to FIG. 16, a wrap 111 is positioned over a segment of pages 16. A back edge portion 118 of wrap 111 is positioned over a rear periphery (not shown since covered by wrap 111) of pages 16. A front side 120 of wrap 111 covers a percentage of surface area of the first lateral side 28 of pages 16. The front side 120 has an exposed surface 121. A rear side 122 of wrap 111 covers a percentage of surface area of the second lateral side 30 of pages 16. The rear side 122 has an exposed surface 123. The rear portion 118 of wrap 111 is secured to the rear periphery of pages 16 by an adhesive such as glue.

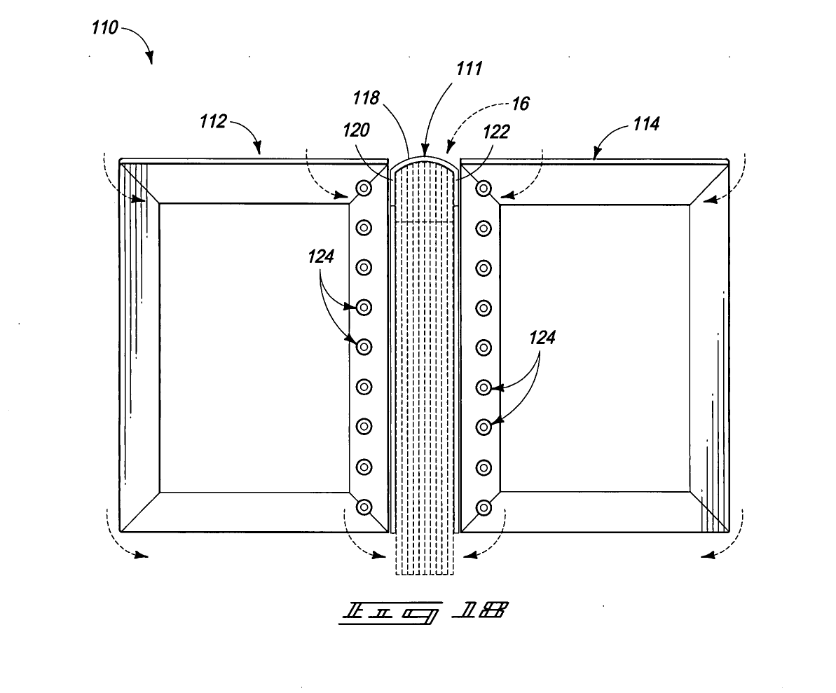

Referring FIG. 17, the exemplary collection of sheets of paper 110 comprises a discrete first cover 112 that is separate from a discrete second cover 114. The first and second covers 112 and 114 are protective covers for a set of pages 16 wherein the first cover 112 is a front cover and the second cover 114 is a rear or back cover (or binder boards). One of various exemplary embodiments of respective covers 112 and 114 includes each having an inside or support structure 115 and an outside or overlay structure 117. An exemplary overlay structure 117 is positioned over an entirety of a first surface (not shown) of support structure 115 and positioned over only a portion of a second surface 119 of the support structure 115 opposite the first surface. The overlay structure 117 is secured to the support structure 115 by at least one of an adhesive (such as glue) and/or a nail or tack.

Still referring to FIG. 17, first and second covers 112 and 114 each have a plurality of openings 124 spaced along a peripheral edge of each cover. An exemplary opening 124 is rimmed with a material 126. An exemplary material 126 includes at least one of metal, cord, fabric, and leather to form an eyelet.

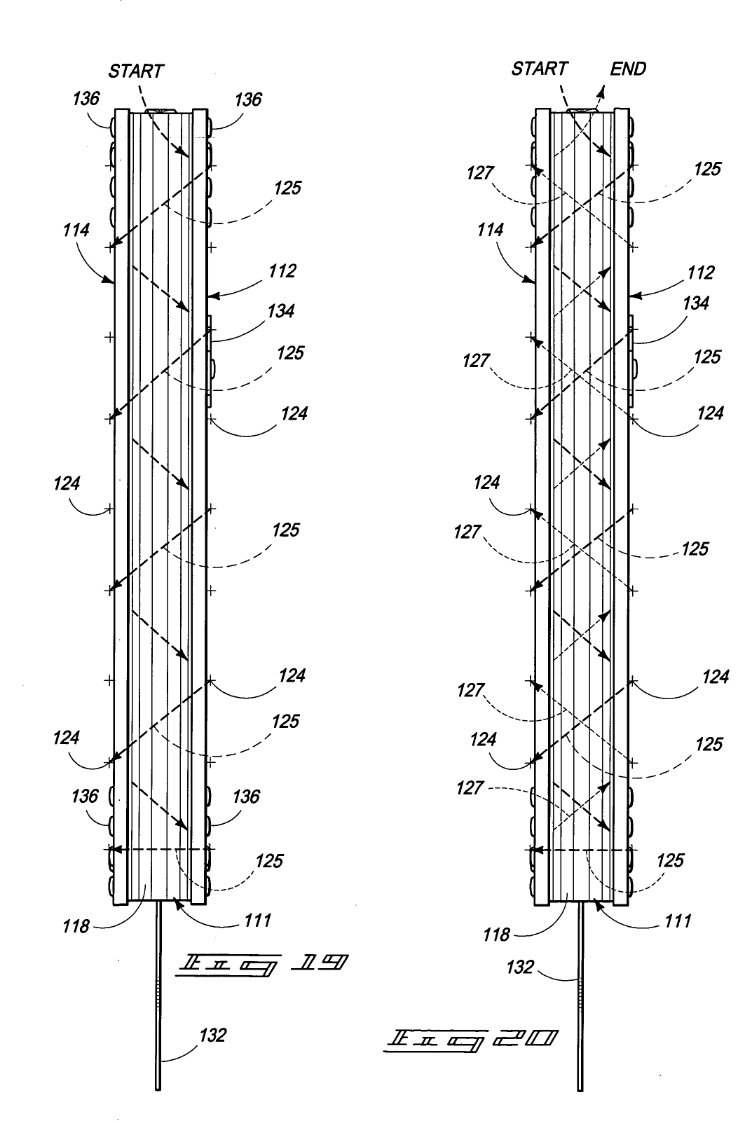

Referring to FIG. 18, an exemplary embodiment of a method for forming the collection of sheets of paper 110 is illustrated and described according to one exemplary embodiment of the invention. Cover 112 is secured by an adhesive to the exposed surface 121 (see FIG. 16) of front side 120 of the wrap 111. Cover 114 is secured by an adhesive to the exposed surface 123 (see FIG. 16) of rear side 122 of the wrap 111. Covers 112 and 114 are secured to wrap 111 with the plurality of openings 124 exposed for access over the wrap 111.

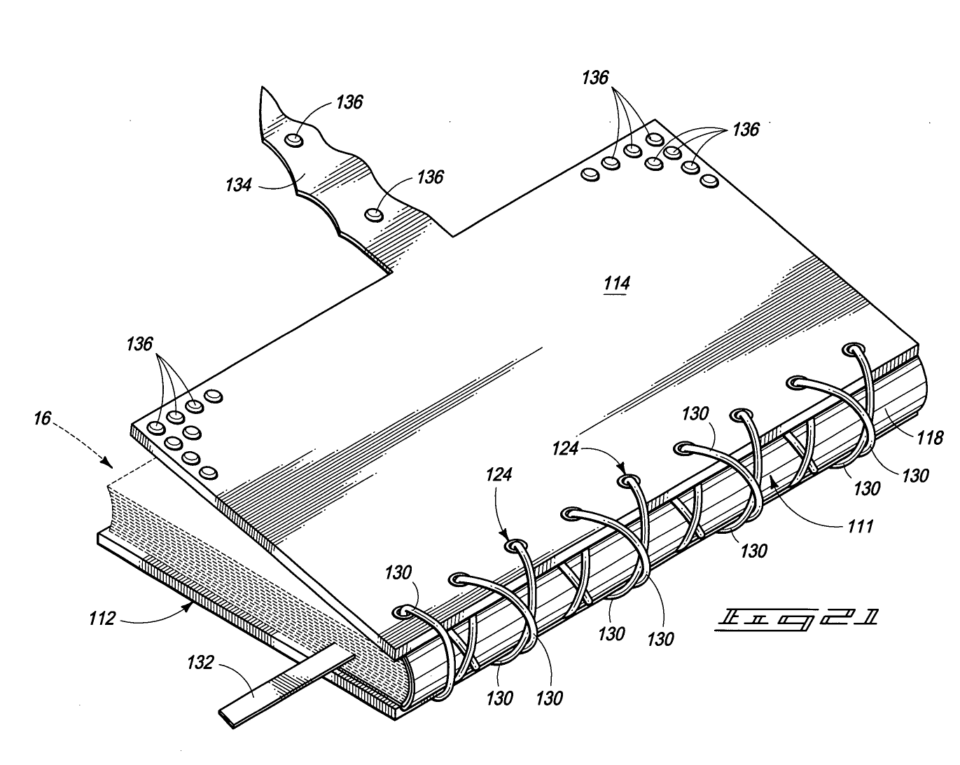

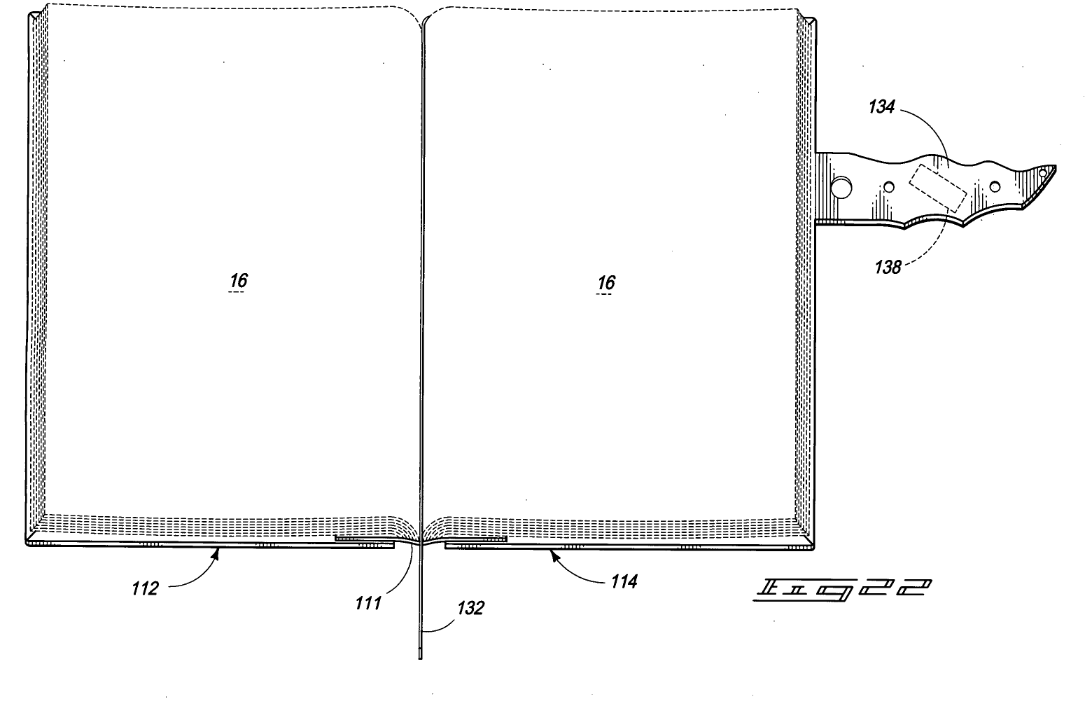

Referring to FIGS. 19-20, an exemplary method for providing a string or strand of material (referenced as 130 in FIG. 21) through openings 124 of respective covers 112 and 114 is illustrated and described. As previously discussed, exemplary materials for the strand or string of material 130 include fibrous material, such as cotton or flax, or other materials such as leather or metal. An exemplary strand or string of material 130 comprises at least one of a cord, yarn, leather, metal, wire, string, ribbon, thread, twine, rope, cable and various combinations of each one. All previous discussions with respect to string 18 are applicable to string 130 including the following discussion for positioning string 130 into respective covers 112 and 114.

Referring to FIG. 19, an exemplary downward direction 125 for positioning the string 130 beings at the top of collection 110 through front cover 112 and moves downward crossing over to the opposite cover until the bottom of each cover is reached. Alternatively, the exemplary direction for positioning the string 130 beings at the bottom of collection 110, or any intermediate location of respective covers 112 and 114, and begins through either one of the covers. Additionally, a plurality of strings 130 can be provided and patterned through respective openings 124 of covers 112 and 114.

Referring to FIG. 20, an exemplary upward direction 127 for positioning the string 130 begins after the downward direction 125 (with crossing over to the opposite cover with string 130 being positioned over or under the previously provided portion of string 130 which was provided in the downward direction 119). Respective ends of string 130 can be secured to one or both of respective covers 112 and 114. In one exemplary embodiment of string 130, string 130 does not form a bookmark for collection 110. However, as shown in FIGS. 19-20, a single bookmark 132 is provided and can be secured or attached to at least one of covers 112 and 114, wrap 111 and/or pages 16. An exemplary collection 110 also includes a clasp 134 and a plurality of knobs or protuberances 136 extending upward from surfaces of respective covers. It should be understood that a plurality of bookmarks can be provided for collection 110.

Referring to FIG. 21, knobs 136 are secured within covers 112 and 114 (and clasp 134) and extend or protrude from outer surfaces of respective covers 112 and 114 (and clasp 134). Knobs 136 can be formed of various materials including metal, plastic, leather, fiberglass and rubber and protect covers 112 and 114, clasp 134 and collection 110 from deterioration when positioned against another surface.

Referring to FIG. 22, an exemplary collection 110 is a journal or diary and is illustrated in an open position. Knobs 136 will protect respective covers 112 and 114 since knobs 136 elevate the surfaces of covers 112 and 114 from making contact with the surface on which journal 110 rests. An exemplary clasp 134 is configured with a magnet or magnetizable material 138 similar to fastener 72 discussed previously. Cover 112 is configured with a magnet or magnetizable material wherein clasp 134 is capable of establishing an attraction relationship with the magnet or magnetizable material in cover 112.

Still referring to FIG. 22, the configuration of this open position is one of various advantages of the present invention. The embodiments of the invention disclosed include discrete covers and a spine comprising a string or strand of material that allows the collection 110 to be in an open position on a surface and remain open without applying a pressure or force to one or both of pages 16 over respective covers. This is not the case with conventional configurations of journals and diaries. Conventional configurations of journals and diaries will require applying a pressure or force to one or both of pages 16 over respective covers to keep the conventional journal or diary open. Alternatively, a great amount of pressure or force can be applied to fold the conventional journal or cover. However, the conventional configuration routinely does not remain with the selected page remaining in position to be viewed. Moreover, with the great amount of pressure or force being applied to fold the conventional journal or cover, a crease in at least the spine develops which can eventually result in a deterioration of the spine until the conventional journal falls apart.

However, the new invention journal or book will remain in the open position without any applied force or pressure allowing a reader (or writer) to relax and concentrate on reading (or writing). Additionally, the journal 110 will remain in an open position on a flat or angled surface. Furthermore, the inventive embodiments will remain open at the selected page unlike a conventional journal.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A collection of sheets of paper, the collection comprising:
a discrete first cover;
a discrete second cover separate from the discrete first cover
a plurality of sheets of paper secured between the first and the second covers;
a string of material extending between the first and the second covers along respective edges of the first and the second; and
wherein the first cover and the second cover comprise the only components of the collection having openings.

2. The collection of claim 1 wherein the string of material comprises at least one of a fibrous material, cord, yarn, leather, string, ribbon, thread, twine, rope and cable.

3. (canceled)

4. The collection of claim 1 wherein the first cover comprises a plurality of loops of material spaced along and extending outwardly from the edge away from the first cover, and wherein the second cover comprises a plurality of loops of material spaced along and extending outwardly from the edge away from the second cover, wherein the plurality of the loops of the first and second covers establishes the openings, and wherein the string of material extends through the respective plurality of loops of material of the first and the second covers.

5. The collection of claim 1 further comprising a bookmark, the bookmark comprising a length of the string of material.

6. The collection of claim 1 further comprising a clasp extending from one of the first and the second covers, the clasp configured to be secured to the other of the first and the second covers.

7. The collection of claim 6 wherein the clasp comprises at least one of a magnetizable material and magnet, and wherein the other of the first and the second covers comprises a magnet, the clasp is configured to be positioned relative the other of the first and the second covers to establish an attraction relationship between the magnet and the magnetizable material.

8. A journal comprising:
a first cover;
a second cover discrete and separate from the first cover;
a plurality of sheets of paper secured between the first and the second covers; and
a spine securing the first cover to the second cover, the spine comprising a string of material other than wire and metal.

9. The journal of claim 8 further comprising a clasp extending from one of the first and second covers and configured to be secured to the other of the first and second covers.

10. The journal of claim 8 wherein each cover comprises at least one opening proximate a peripheral edge of each cover, and wherein the spine comprises the string of material extending through each of the at least one opening of each cover.

11. The journal of claim 8 wherein each cover comprises a plurality of openings spaced along a peripheral edge of each cover, and wherein the spine comprises the string of material extending through at least two of the plurality of the openings of each cover.

12. The journal of claim 8 wherein each cover comprises a plurality of loops of material spaced along and extending outwardly from a peripheral edge of each cover, and wherein the spine comprises the string of material extending through at least two of the plurality of the loops of material of each cover.

13. The journal of claim 8 wherein each cover comprises a plurality of protuberances of material extending outwardly from an outer surface of each cover.

14. A method of forming a collection of sheets of paper, the method comprising:
providing a plurality of sheets of paper;
securing the plurality of the sheets of paper between a first cover and a second cover, the first cover is separate and discrete from the second cover; and
forming a spine along a peripheral edge of the plurality of the sheets of paper, the spine comprising a strand of material extending from the first cover to the second cover without the strand of material extending through the plurality of the sheets of paper.

15. The method of claim 14 wherein the forming of the spine comprises weaving the strand of material through a plurality of openings spaced along the peripheral edges of each cover.

16. The method of claim 14 wherein the strand of material comprises at least one of a fibrous material, cord, yarn, leather, string, ribbon, thread, twine, rope and cable.

17. The method of claim 14 further comprising providing a bookmark, the bookmark comprising a length of the strand of material extending from the spine.

18. A method of replacing a cover structure for a collection of sheets of paper, the method comprising:
removing a plurality of sheets of paper from a cover structure;
providing a discrete first cover;
providing a discrete second cover, the discrete first and second covers having openings spaced along respective periphery edges;
securing the plurality of the sheets of paper between the first and the second covers; and
threading a strand of material in a crisscrossing pattern through the openings of the first and the second covers.

19. The method of claim 18 wherein the threading occurs before the securing.

20. The method of claim 18 wherein the securing occurs before the threading.

21. The collection of claim 1 wherein the string of material is devoid of a structure configured to prevent dislocation of the string of material from the first and the second covers.

22. The collection of claim 1 wherein the openings are cylindrically-shaped openings having height dimensions extending parallel with the respective edges of the first and the second covers.

23. The journal of claim 8 further comprising a plurality of bookmarks, the plurality of bookmarks comprising different sections of the string of material.

24. The journal of claim 8 wherein the string of material is in a crisscrossing pattern between the first and the second covers.

25. The method of claim 14 further comprising providing the strand of material in a crisscrossing pattern between the first and the second covers.

26. The method of claim 18 wherein the openings are cylindrically-shaped openings having height dimensions extending parallel with the respective periphery edges of the first and the second covers.
